(19) United States
(12) Patent Application Publication
(10) Pub. No.: US 2013/0262208 A1
(43) Pub. Date: Oct. 3, 2013

(54) Peer-to-Peer Distribution of Advertising

(71) Applicants: Anand P. Rangarajan, Hillsboro, OR (US); Victor B. Lortz, Beaverton, OR (US); Vijay Sarathi Kesavan, Hillsboro, OR (US); Somya Rathi, Portland, OR (US); Xingang Guo, Portland, OR (US)

(72) Inventors: Anand P. Rangarajan, Hillsboro, OR (US); Victor B. Lortz, Beaverton, OR (US); Vijay Sarathi Kesavan, Hillsboro, OR (US); Somya Rathi, Portland, OR (US); Xingang Guo, Portland, OR (US)

(21) Appl. No.: 13/992,801

(22) PCT Filed: Nov. 30, 2011
(86) PCT No.: PCT/US11/62499

§ 371 Date: Jun. 10, 2013

(51) Int. Cl. G06Q 30/02

(52) U.S. Cl. CPC G06Q 30/0261
USPC 705/14.16; 705/14.58; 705/14.63

(57) ABSTRACT

Advertising may be distributed over a location based peer-to-peer network. A first customer may send a received advertisement to other customers over a short range distribution system in some embodiments. An identifier of the first customer may be appended to the transmission. The identifier may be used to reward the first customer for the referral.

### BACKGROUND

This relates generally to location based advertising.

Location based advertising is advertising that is determined by the consumer's current position. Generally, a computer device with a global positioning system sensor sends its coordinates to a centralized operator. The centralized operator uses those coordinates to select advertisements that are pertinent to the user's current location. For example, when the user is close to a particular grocery store, coupons or advertisements sponsored by that grocery store may be forwarded to the user.

One advantage of the location based advertising, particularly in connection with consumers who are driving automobiles, is that they do not need to be burdened with a large mass of irrelevant data. This improves driver safety and probably results in the consumer paying greater attention to the advertisements that are actually received.

### BRIEF DESCRIPTION OF THE DRAWINGS

FIG. 1 is a schematic depiction of one embodiment of the present invention;

FIG. 2 is a flow chart for a peer-to-peer ad distribution system in accordance with one embodiment of the present invention;

FIG. 3 is a flow chart for a sequence for redeeming coupons according to one embodiment; and

FIG. 4 is a schematic depiction of a receiver according to one embodiment.

### DETAILED DESCRIPTION

In accordance with some embodiments, advertisements may be distributed through a peer-to-peer advertising distribution system. Particularly, a consumer who receives advertisements may be referred to herein as a referring customer. The referring customer may receive advertising, such as advertisements for products, special offers, and coupons. The referring customer, in some embodiments, may screen advertising based on the customer's current position. As a result, the customer may only receive those advertisements that are relevant to the customer's current geographic position.

The referring customer may then electronically, automatically transmit the advertisements to other referred customers that are proximate to the referring customer. The referring customer's computer may automatically append an identifier that identifies the referring customer. Then when the referred customer attempts to use the advertising, the referring customer may get credit because his identity can be deduced from the identifier which has been appended to the advertising when it was sent to the referred customer.

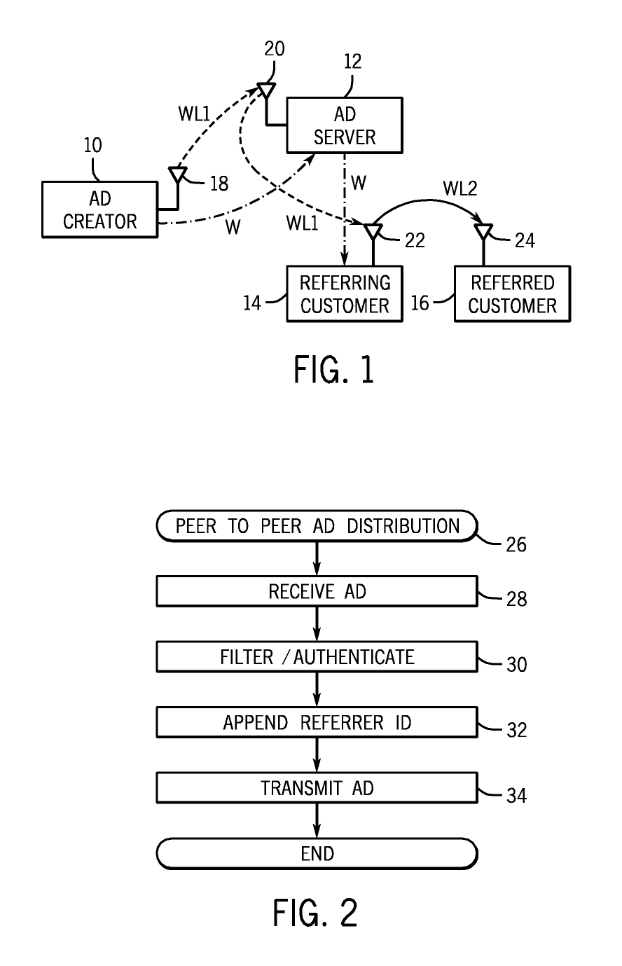

Thus, referring to FIG. 1, in accordance with one embodiment, an advertising (ad) creator 10 may create an advertising. The creator may be a computer associated with a store or service provider, as examples. The creator may also be a computer at an advertising agency. The creator then transmits the advertising to an advertising (ad) server 12. It may transmit the advertising over a wired connection, as indicated by the arrows marked W, or by a wireless connection, as indicated by the arrows marked WL1 between the antenna 18, associated with the ad creator 10, and an antenna 20, associated with the advertising (ad) server 12.

The goal of the ad server 12 may be to distribute the advertising on a geographically unlimited basis or a geographically limited basis. One advantage of distributing the advertisements on a geographically limited basis is that only customers who are in a particular region of interest may receive the advertising. For example, the ad server 12 may distribute advertising using a shorter range wireless protocol that restricts the region where it can be received. As another option, the server 12 may distribute the advertising only to particular individuals who are identified as being of interest to the particular ad. Then only customers may only receive advertising from vendors close to the customer's current position.

Thus, the advertising server may distribute advertising by a wired connection marked W from the ad server 12 to the referring customer 14 or by a wireless connection, indicated as WL1, between the antenna 20 on the ad server 12 and an antenna 22 associated with the referring customer 14. Normally, the referring customer 14 is associated with a processor-based device, such as a mobile device, including an in-car computer or a cellular telephone.

Then the referring customer 14 may transmit the advertising, for example by a wireless connection WL2, between the referring customer's antenna 22 and a referred customer's antenna 24. In some embodiments, the referring customer 14 may use a relatively short range wireless protocol so that only referred customers 16 proximate to the referring customer 14 and, thereby, proximate to the geographic area of interest, may receive the advertising.

The computer of the referring customer 14 may automatically append an identifier that has been registered with the ad server or the ad creator so that the identity of the referring customer 14 will be known. If the referred customer 16 then uses the advertising, for example by caching in a coupon, the referring customer's identifier may be obtained and, as a result, the referring customer 14 may be rewarded.

In some embodiments, a peer-to-peer network is established with other proximate consumers. The network may be ad-hoc in that anyone proximate may get the advertising. As another option, only contacts (persons on the referring customer's contact list) receive the advertising. As still another option, only in-range customers who have indicated an interest in receiving the type of advertising involved receive or accept the advertising.

When the referred customer 16 decides to redeem a coupon, for example, the referred customer 16 may need to transfer the advertising from a receiving computer to another computer, such as a handheld computer, so that it can be taken into a retail facility for use. For example, in many cases, the advertising may be received by the referring customer on an in-car infotainment system.

To redeem a coupon, a customer may simply transfer the coupon from the user's computer to a handheld device. For example, the customer may transfer the advertisement from an in-car personal computer to a cellular telephone using a cellular link, a WiFi connection, near field communication (NFC), an optical connection, a QR code, or any other connection.

In some embodiments, the referring customer may receive the advertising only when the referring customer is on the site of the ad creator or nearby. This geographic distribution limitation may be accomplished in a variety of ways, including using a WiFi broadcast, a short range radio broadcast to a membership card used by the referring customer, a short range broadcast to the referring customer's cellular telephone, or an optical transmission in the course of a transaction, such as a purchase. The transfer can even be done using near field communication technology. Another mechanism for transferring such advertising may be to use QR codes. The QR codes may be imaged and then stored on a device, such as a camera or cellular telephone. From there they can be transferred as described above.

Thus, referring to FIG. 2, a peer-to-peer ad distribution sequence 26 may be implemented by the referring customer 14's computer, which may be a mobile device, such as a cellular telephone or a mobile Internet device. In some embodiments, the sequence may be implemented using software, firmware, and/or hardware. In software and firmware embodiments, it may be implemented using computer executed instructions stored in a non-transitory computer readable medium, such as an optical, magnetic, or semiconductor memory.

The sequence 26 may begin by receiving the advertising 28 by a wired or wireless transmission. The received advertising may then be filtered and authenticated, as indicated in block 30. The filtering may be based on subject matter, locality, or any other basis. For example, targeted advertising may be used. The authentication may be to check whether the advertising distributor is signed by a source that is considered reliable. If the filtering and authentication is successful, a referring identifier may be appended to the advertising, as indicated in block 32. Then the advertising with the referring identifier may be transmitted, as indicated in block 34.

The advertising may be used in a store, for example by presenting an electronic version of the advertising in the store. The electronic version of the advertising may include the referring identifier. In some cases, multiple referring identifiers may be appended.

A sequence 36, for redeeming the advertising, may be implemented in software, firmware, and/or hardware. In software and firmware embodiments, it may be implemented using computer readable instructions stored on a non-transitory computer readable medium, such as a magnetic, optical, or semiconductor storage.

The sequence may begin, in one embodiment, by storing the advertising in a suitable memory in a computer system, as indicated in block 38. Then, any appended referring identifiers may be parsed, as indicated in block 40. Next, the computer may automatically compensate the referrer, as indicated in block 42, by sending additional coupons, providing an additional credit, or by accruing any other type of compensation.

The referring customer will receive the advertising if he or she is sufficiently close to the ad server that may need to be sufficiently close to the ad creator in some embodiments. A limited range broadcast may effectively cull ads so that only local customers receive them in some embodiments.

Another option is that the referring customer's computer automatically checks locality information provided with the advertising to see if the advertising is pertinent to the referring customer's current position.

In accordance with another distribution technique, the advertising creator may send the advertising via a wireless link WL1 from an antenna 18 to an antenna 20, associated with the ad server 12. Then the ad server 12 can distribute either wirelessly via the connection WL1 or by a wired connection, as indicated by W, to a referring customer 14.

Once the referring customer 14 has the advertisement, the referring customer, in some cases, may transmit the advertisement using a limited range wireless protocol WL2 to referred customers 16 within range of the referring customer. As a result, if the advertising is locally pertinent to the referring customer 14. If the range of WL2 is sufficiently short, the referred customer 16 will only receive ads that are locally pertinent, in some embodiments. Thus, the connection WL2, from antenna 22 to antenna 24, may be over a WiFi or WiMAX connection, in some embodiments. It may even be a shorter range transmission, such as a Bluetooth wireless signal, in some embodiments.

In some embodiments, the customers 14 and 16 may communicate with cellular telephones, laptop computers, mobile Internet devices, or other wireless devices. In other embodiments, the customers may communicate over communication systems that are available within their personal vehicles. Thus, in some cases, a computer may be resident within each customer's vehicle, which may receive the communications over one or more available communication protocols.

Referring to FIG. 4, the referring customer 14 receiver, in accordance with one embodiment, may include the antenna 22, coupled to a wireless transceiver 44. In some embodiments, the transceiver 44 may be a short range receiver/transceiver, such as a WiFi receiver/transceiver. As a result, only geographically pertinent advertisements may be received and only geographically proximate receivers can receive advertisements transmitted.

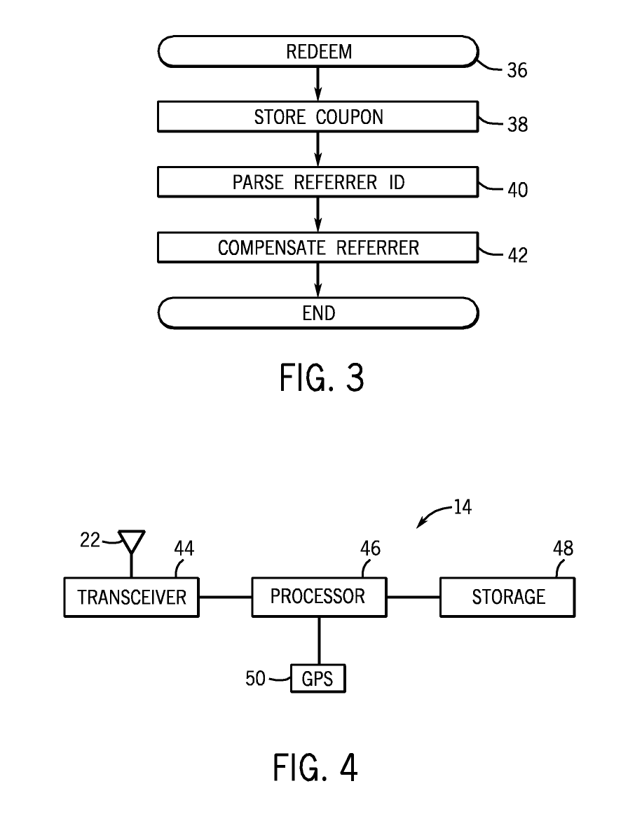

The transceiver 44 may be coupled to a processor 46 in some embodiments. The processor 46 may, in turn, be coupled to a storage 48. In software and firmware embodiments, it may store the sequence of FIG. 2 and/or the sequence of FIG. 3. A position sensor, such as a global positioning system (GPS) sensor 50, may be coupled to the processor 46. The processor 46 may use the sensor 50 to determine its current location and to use that information to filter advertisements received from the ad server 12 for geographical pertinence to the receiver 14's current position.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
distributing location based advertisements over a peer-to-peer network.

2. The method of claim 1 including transmitting said advertisements to consumers proximate to an advertiser.

3. The method of claim 1 including automatically causing a first consumer to transmit an advertisement to other consumers.

4. The method of claim 3 including appending an identifier to identify the first consumer that broadcasts the advertisement to another consumer.

5. The method of claim 4 including using the identifier to reward the first consumer.

6. The method of claim 5 including harvesting the identifier when the advertising is redeemed by another consumer.

7. The method of claim 1 including enabling location based advertising by using a WiFi transmission from said first consumer.

8. The method of claim 1 including distributing said advertising to an in-car computing device.

9. The method of claim 8 including filtering received advertising based on vehicle location.

10. The method of claim 1 including establishing an ad-hoc advertising distribution network.

11. A non-transitory computer readable medium storing instructions executed by a computer to:
distribute location based advertisements over a peer-to-peer network.

12. The medium of claim 11 further storing instructions to transmit said advertisements to consumers proximate to an advertiser.

13. The medium of claim 11 further storing instructions to cause a first consumer to transmit the advertisement to another consumer.

14. The medium of claim 13 further storing instructions to append an identifier to identify the first consumer that broadcasts the advertisement to another consumer.

15. The medium of claim 14 further storing instructions to use the identifier to reward the first consumer.

16. The medium of claim 15 further storing instructions to harvest the identifier when the advertising is redeemed by another consumer.

17. The medium of claim 11 further storing instructions to enable location based advertising by using a WiFi transmission from said first consumer.

18. The medium of claim 11 further storing instructions to filter received advertising based on vehicle location.

19. The medium of claim 11 further storing instructions to establish an ad-hoc advertising distribution network.

20. An apparatus comprising:
a server to distribute location based advertisements over a peer-to-peer network; and
an antenna coupled to said server.

21. The apparatus of claim 20, said server to transmit said advertisements to consumers proximate to an advertiser.

22. The apparatus of claim 20, said server to automatically cause a first consumer to transmit an advertisement to another receiver.

23. The apparatus of claim 22, said server to append an identifier to identify the receiver that broadcasts the advertisement to another receiver.

24. The apparatus of claim 23, said server to use the identifier to issue a reward.

25. The apparatus of claim 24, said server to harvest the identifier when the advertising is redeemed by another consumer.

26. An apparatus comprising:
a transceiver to receive a wirelessly transmitted advertisement and to transmit said advertisement to another receiver; and
a processor to filter said advertisement based on a geographical limitation included with said advertisement and to append an identifier onto said advertisement when it is transmitted.

27. The apparatus of claim 26 wherein said apparatus is one of a cellular telephone, a computer, or an in-car computing device.

28. The apparatus of claim 26 wherein said transceiver to transmit a WiFi message.

29. The apparatus of claim 26 including a position sensor.

30. The apparatus of claim 29, said processor to use said position sensor to filter advertisements for geographical pertinence.
